(19) United States
(12) Patent Application Publication
(10) Pub. No.: US 2022/0263651 A1
(43) Pub. Date: Aug. 18, 2022

(54) CUSTODIAL INTEGRITY FOR VIRTUAL DIGITAL ASSETS AND RELATED TECHNOLOGIES

(71) Applicant: Benjamin Allan Mord, Scarsdale, NY (US)

(72) Inventors: Benjamin Allan Mord, Scarsdale, NY (US); Allan J. Mord, Boonton, NJ (US)

(21) Appl. No.: 17/625,282

(22) PCT Filed: Jul. 9, 2020
(86) PCT No.: PCT/US2020/041325

§ 371 Date: Jan. 6, 2022

Related U.S. Application Data
(60) Provisional application No. 62/873,626, filed on Jul. 12, 2019.
(60) Provisional application No. 62/881,963, filed on Aug. 2, 2019.

(51) Int. Cl. H04L 9/08; H04L 9/32

(52) U.S. Cl. CPC H04L 9/0825; G06Q 20/3829; H04L 9/3247

(57) ABSTRACT

Described are techniques for providing custody of digital assets with a high degree of assurance of a proof that private keys are kept secret and not in possession of entities that should not have access to such keys. The techniques include a deployed space-borne vehicle that includes a data processing node that generates a remote custody key (RCK) pair, the RCK pair including a private RCK key known only to the data processing node and a public RCK key, upon receiving an indication of the deployment to the space-borne location and that establishes a communication channel between the deployed space-borne vehicle and a terrestrial based system, with the communication channel authenticated by a physical, earth-based item that is remotely identifiable by the space-borne vehicle.

### CLAIM OF PRIORITY

This application claims priority under 35 USC § 119(e) to U.S. Provisional Patent Application Ser. No. 62/873,626, filed on Jul. 12, 2019, and entitled “REMOTE CUSTODIAN SAFEGUARDING DIGITAL ASSETS” and to U.S. Provisional Patent Application Ser. No. 62/881,963, filed on Aug. 2, 2019, and entitled “CUSTODIAL INTEGRITY FOR VIRTUAL DIGITAL ASSETS AND RELATED TECHNOLOGIES,” the entire contents of which are hereby incorporated by reference.

### BACKGROUND

This specification relates to custodial practices in securing digital assets.

A custodian is typically a financial institution that holds client's financial assets, e.g., securities for safekeeping to minimize risk of theft or loss. Presently, a custodian holds securities and other assets in either electronic or physical form.

One type of digital asset is cryptocurrency. Cryptocurrency is an example of a digital token. A Digital token is an example of a virtual property that is typically secured by private key. In order for a custodian to safeguard a digital token, such as a cryptocurrency, the private key must be kept secret. While custodians can demonstrate that they know the private key during an audit (even without revealing the private key to auditors), custodians cannot demonstrate that no entities that are not supposed to know the key, do not in fact have copies of the private key. This limitation prevents custody services from complying with pertinent custodial regulations, such as the Securities and Exchange Commission's Customer Protection Rule (SEC Rule 15c3-3).

### SUMMARY

More generally, this problem with private keys complicates crafting of institutional trust relationships whose assurance or duration exceed the trust relationships among individuals, when some of the underlying enforcement mechanisms are cryptographic in nature.

According to an aspect a method of operating a deployed space-borne vehicle that includes a data processing node includes generating by the data processing node that is deployed to a space-borne location a remote custody key (RCK) pair, the RCK pair including a private RCK key known only to the data processing node and a public RCK key, upon receiving an indication of the deployment to the space-borne location; and establishing a communication channel between the deployed space-borne vehicle and a terrestrial based system, with the communication channel authenticated by a physical, earth-based item that is remotely identifiable by the space-borne vehicle.

The above aspect may include amongst other features one or more of the following features.

Establishing the communication channel includes encrypting information over the communication channel. Causing by the data processing node signing of information transmitted to the one or more terrestrial electronic devices using the private RCK and transmitting signed information over the communication channel. The physical, earth-based item is one or more specified plots of land or a collection of long-lived qubits that were entangled, prior to launch with corresponding long-lived qubits inside the space-borne vehicle tangible stored on non-transitory computer readable media and thus being “physical” to distinguish incoming transmissions from those of adversary transmissions.

The channel uses lasers for communication of information, with a first laser disposed at the references physical, earth-based item and a second, optional laser that is disposed at the space-borne vehicle. The space-borne vehicle includes one or more lenses or mirrors (or both) in the space-borne vehicle to focus incoming laser beams on a sensor that is positioned such that only light originating from within the expected physical, earth-based item can illuminate the sensor.

The private keys are used in establishing a custodial relationship between the space-borne vehicle that is a satellite, and digital token assets. The digital token assets are cryptocurrency assets.

The data processing node receives an operational command over the communication channel for the data processing node to sign specified data, using a specified private key known only to the satellite, with a specified signature algorithm according to the type of assets whose custody is secured. The data processing node determines if a current time is within an interval designated for operation; upon being in the interval the node receives a physically authenticated command, broadcasts that command back to Earth, and listens for any physically authenticated “short panic” commands over a time interval. When one or more short panic commands are received the node discards any received commands and does nothing until a next designated time interval for operation, else, determines the command received, where the command can include one or more of an audit command, a RCK generate command, a command to sign included data, and a panic command.

Other aspects include systems and computer program products.

One or more of the above aspects may provide one or more of the following advantages.

The disclosed mechanisms may advantageously leverage physical inaccessibility of, e.g., spacecraft and/or other remote platforms to provide information integrity guarantees that are secured by a type of physical item or items that secure the communication channel, safeguarding access to private keys generated by and used by the node to sign transactions, etc. Unique integrity benefits are provided to enable private key generation, storage and usage facilities in physically inaccessible space-borne hardware, whose design and manufacture may be subject to audit, thus physically eliminating the possibility of unauthorized private key copies being unlawfully or inappropriately obtained and providing a solution to securing digital tokens such as cryptocurrency, as well as other virtual property or keys by private keys in custodial arrangements. Custodians can demonstrate control of a private key during audit (even without knowing the private key), and can also demonstrate that no entities who are not supposed to control this key, do not in fact control this key, thus enabling custody services to comply with pertinent regulations regarding providing custodial services for digital tokens.

Similarly, the disclosed mechanisms may be used to secure signing keys that are used for other purposes such as signing software updates, signing secure socket layer (SSL) or other public key infrastructure (PKI) digital certificates issued by certificate authorities (CAs), signing smart or conventional digital contracts, certifying titles, certifying passports, signing receipts, signing control or other commands for automated or manual distributed or remote systems, or any other application requiring high assurance limitations on control of one or more signing keys.

Once such hardware is appropriately designed, built, and deployed into orbit or otherwise into space, it can serve (individually or in aggregate, alone or in conjunction with other signature processes) as a secure custodian. This hardware can be designed to sign transactions or other data only when so instructed over communication channels that have been authenticated by the instructor's possession of physical items which are of a type that (unlike private keys) cannot be duplicated, such as a plot of land. In this manner, satellites or other space-borne hardware can serve as secure vaults for digital tokens, or for signatory authority more generally.

The details of one or more embodiments of the invention are set forth in the accompanying drawings and the description below. Other features, objects, and advantages of the invention are apparent from the description and drawings, and from the claims.

### DESCRIPTION OF DRAWINGS

FIG. 1 is a block diagram of an exemplary system.

FIG. 2 is a block diagram that illustrates an exemplary data processing node that may be used with the system of FIG. 1.

FIG. 3 is a diagram that illustrates a set-up of an authenticated communication channel with the system of FIG. 1.

FIG. 4 is a flow diagrams that depict processes carried out at spacecraft and/or other physically inaccessible platforms for securing private keys for a custodian platform.

FIG. 5 illustrates an exemplary device that can be configured in accordance with the various aspects and embodiments described herein.

### DETAILED DESCRIPTION

The present disclosure describes data processing platforms located in physically inaccessible, physically remote, high velocity, inhospitable, or other such environments that function as highly secure custodial entities for securing private signing keys such as for digital assets and digital tokens such as cryptocurrencies. The data processing platforms are responsible for private key generation, storage and usage. The data processing platforms are custodial facilities located in physically inaccessible space-borne hardware, whose design and manufacture can be subject to audit.

Once such data processing platforms are appropriately designed, built, and deployed, the data processing platforms serve (individually or in aggregate, alone or in conjunction with other signature processes) as secure custodian entities. The data processing platforms are configured to sign transactions or other data only when so instructed over communication channels that have been authenticated by possession of physical item(s) that are of a type that cannot be duplicated (unlike private keys). Examples of such physical items include specified plots of land. In this manner, satellites or other space borne hardware can serve as secure vaults for digital tokens, or for signatory authority more generally.

Physical remoteness or physical inaccessibility of a processing node (e.g., spacecraft, satellites, etc.) provide intrinsic security advantages, including that the processing node is difficult to physically access and manipulate, and that side channels such as inadvertent low-power electromagnetic emissions are difficult to monitor. The processing node is disposed in space-borne hardware, such as a “satellite,” that can be placed in close or distant orbit around Earth, e.g., a low Earth orbit (LEO), a geostationary orbit (GEO), a geosynchronous orbit (GSO), a Mars intercept orbit, or another suitable orbit depending on data integrity requirements, technological capabilities, etc. For example, space-borne hardware traveling away from Earth with velocity greater than escape velocity would enjoy a form of physical security that increases over time, countering the increasing technological sophistication of potential adversaries. Space-borne hardware placed on the Earth-side surface of the moon would have surroundings illuminated by both direct and reflected sunlight, facilitating the detection of adversaries.

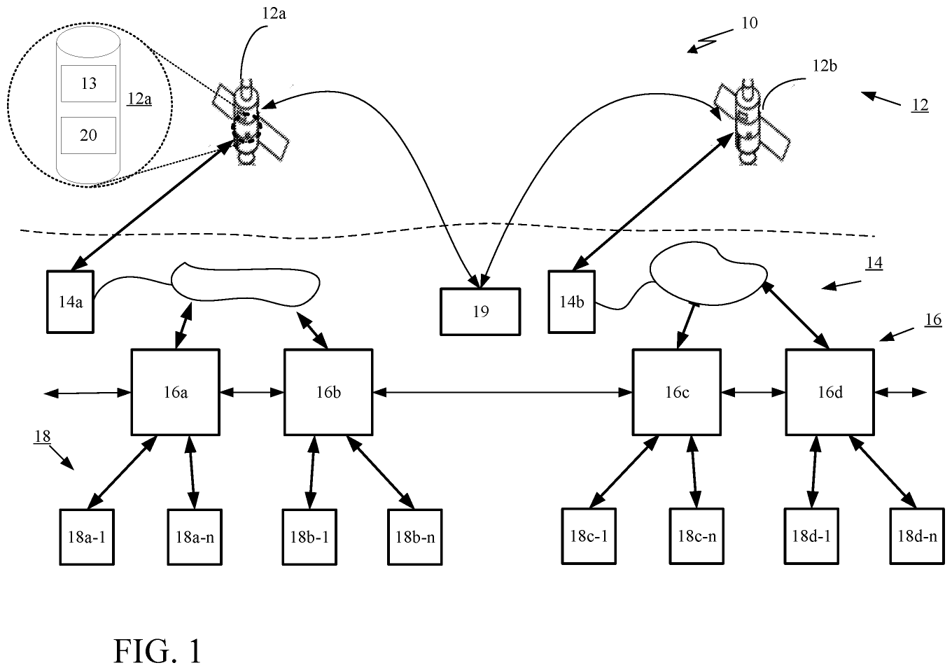

Referring now to FIG. 1, an exemplary system 10 that uses space-borne hardware, e.g., satellites carrying data processing nodes, as a physically inaccessible platform to secure private key generation, storage and use is shown. The system includes one or more physically inaccessible platforms, e.g., satellites 12a, 12b, etc. The satellites 12a, 12b each include a data processing node 20. The system 10 can include one or more satellites (only two satellites 12a, 12b being shown in FIG. 1) that are either identical in design or that may be different in design. However, although the satellites may potentially have different designs, each satellite is manufactured to satisfy certain data integrity design constraints. Each of the one or more satellites 12a, 12b has an owner that communicates with the one or more satellites 12a, 12b, via corresponding owner systems 14a, 14b (only two being shown). Each satellite 12a, 12b includes one or more secret random data strings known only to the satellite 12a, 12b (i.e., the data processing node 20) and the corresponding owner system 14a, 14b of the satellite 12a, 12b or may use a physical token such as land for authentication.

The system 10 further includes one or more operational command systems (generally 16) per satellite 12, which may or may not be the same as the owner systems 14. For example, operational command systems 16a, 16b are associated with satellite 12a, and operational command systems 16c, 16d are associated with satellite 12b, etc. The system 10 may further include one or more user systems (generally 18) that are involved with digital transactions for which the operational command systems communicate with the digital processing node(s) 20. In addition, the system 10 may optionally include one or more independent observer systems 19 that may include services/applications for auditing the satellites 12 by auditors, regulators, competitors, security researchers, and/or other entities for public or private ongoing skeptical evaluation of the design and operation of the system 10. As shown, the satellite 12a also includes a communication receiver 13 that is used to establish a secure communication channel between the satellite 12a and one or more terrestrial-located systems, e.g., owner system 14 and optionally operational command systems 16.

This hardware can be designed to sign transactions or other data only when so instructed over communication channels that have been authenticated by the instructor's possession of physical items which are of a type that (unlike private keys) cannot be duplicated, such as a plot of land. In this manner, satellites or other space-borne hardware can serve as secure vaults for digital tokens, or for signatory authority more generally

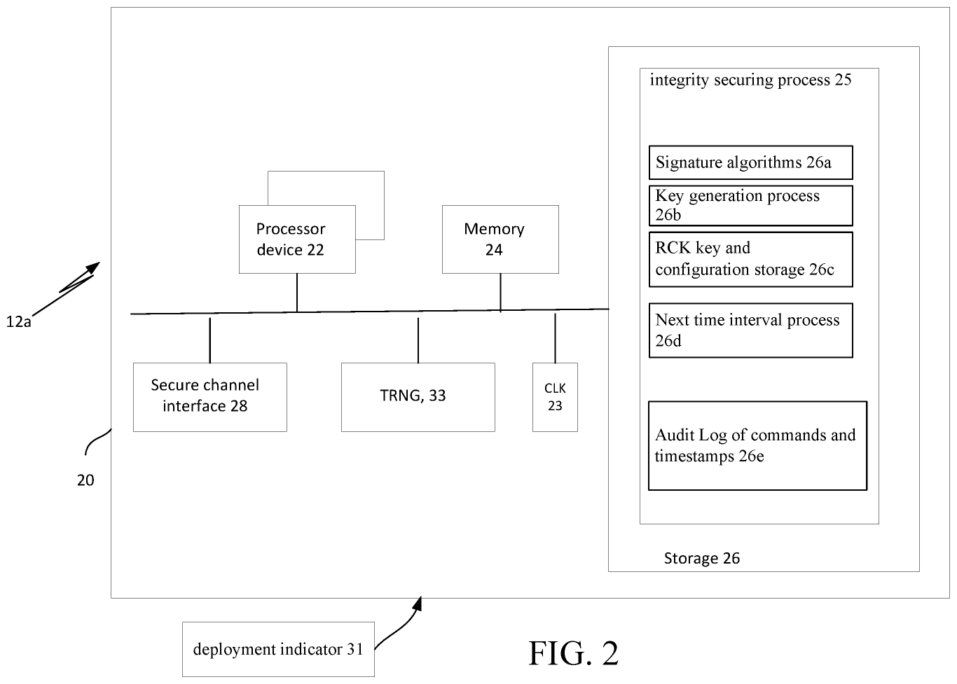

Referring now to FIG. 2, the data processing node 20 for satellite 12a is shown as including one or more processor devices 22, memory 24 operatively coupled to the one or more processor devices 22, a clock 23, and one or more random number generators 33. In particular, true random number generators (TRNG) are used, but in some instances pseudo random number generators could be used provided that they are seeded by a high-entropy source. The data processing node 20 also includes storage 26 and a secure channel interface 28 that can be a network interface, serial interface, communication port, etc., that is coupled to a space-borne hardware receiver 13 (FIG. 1). In some implementations, the space-borne hardware receiver 13 is a directional receiver, meaning that it is configured to receive transmissions from a specific location, e.g., on earth. (Other conventional details of the processing node 20 may be included but are not shown.) The data processing node 20 for satellite 12a is typical for all of the data processing nodes 20 for the satellites 12b, etc.

The manner in which the satellite's 12a private keys are produced serve a purpose of assuring auditors that unknown entities neither possess a copy of the private keys nor can direct the use of the private keys, except via access to a difficult-to-duplicate item, regardless of operator intent.

Private keys that are part of a remote custody key-pair (RCK) 26c (discussed below) may be generated by the satellite. For example, one technique is by use of the bitwise “exclusive or” (XOR) operations to combine outputs of multiple onboard high-entropy secure true random number generators 33. Different types of true random number generators 33 may employ different entropy sources, such as thermal resistor noise, Geiger counter output, background microwave radiation sampling, etc., and they may be sourced from different vendors, with each designed to contribute sufficient entropy for a fully secure key even without contribution from other vendors.

An RCK pair as used herein is part of a signature algorithm 26a and encompasses any technical approach for communicating tamper-resistant information integrity, comprising a private RCK and a public RCK, where the private RCK conveys integrity assurance, and the public RCK validates such integrity assurance. One example, without limitation, would be an ECDSA private/public key-pair for use with the ECDSA signature algorithm (Elliptic Curve Digital Signature Algorithm). Another example also without limitation would be a private seed and iterative hash value for use with the TESLA (Tightly-Secure Efficient Signatures from Standard Lattices) or DHKR (Delayed Chained Key Revelation) algorithms. Others are also possible.

In this manner, the correctness of any single random number generator may ensure security of the resulting private keys. Any telemetry systems that may leak side channel information such as high-fidelity power or CPU load monitoring, as well as any remotely programmable SDR hardware that may be present, could be disabled during sensitive key generation, usage, or other operations.

The hardware design, component sourcing and manufacturing process may be subject to external security audit to guard against intentional or accidental back doors, and a chain of custody for the satellite may be carefully tracked after manufacture up to time of launch and deployment to prevent or detect tampering.

In one embodiment, the satellites generate new private keys in response to commands coming from authorized plots of land during authorized time intervals, and the associated public keys are transmitted back to these same plots of land for purpose of receiving assets for custody or for purpose of verifying subsequent signatures.

In other implementations, the associated public keys are transmitted back to different plots of land that are designated for that purpose of receiving assets for custody or for the purpose of verifying subsequent signatures. Key generation commands may further stipulate specific uses of certain keys, or specific usage time slots to sort into an appropriate diligence tier, or may stipulate that authorized signing commands may come only from certain plots of land associated with that key's desired jurisdiction or level of security.

The storage device 26 stores an integrity securing process 25 for information. The data processing node 20 of the satellite 12a includes one or more secure random number generators (e.g., TRNG) 33 for use in key generation algorithms 26b to produce one or more RCK 26c. The RCK key-pair uses a combination of a public key and a private key-pair. The public key of a RCK key-pair is disseminated widely, while the private key of the RCK key-pair is held secret known only to the producer/signer of information that is being verified. The data processing node 20 includes the module 26b for generation of such RCK key-pairs 26c. Security requires keeping the RCK private keys private, while the public key can be distributed without compromising security.

In the context of the system 10, the private key is only known to the data processing node 20 on the satellite 12 (i.e., the private RCK may be unknown even to the owner system 14 of the corresponding satellite 12). The public key is known to all participants in the system 10. Also included are a next time interval process 26d and audit log of command and timestamps process 26e, discussed below.

In some implementations, the data processing node 20 includes or is coupled to a deployment indicator 31. The deployment indicator 31 provides a signal to the data processing node 20 that indicates the deployment of the satellite 12a has been deployed at or is on its way to the physically inaccessible location. The indicator would typically be an indication that the satellite was deployed at the physically inaccessible location. The deployment indicator 31 signal is fed to the data processing node and used by the module 26f that generates the RCK key-pair by the data processing node 20. Upon receipt of the indicator signal, the module 26f generates the RCK key-pair.

The deployment indicator 31 can be any device that generates the signal under configured for circumstances and that is a tamper resistant mechanism. For example, the deployment indication 31 can be a time delay from a launch command signal sent to a rocket that deploys the satellite, a signal generated by an altimeter that signals when the satellite reaches its deployed altitude, etc.

The applicable data integrity design constraints may optionally further require each satellite 12 to have a one-time use mechanism 26h that permanently disables setup commands. For example, the satellites 12 and/or the data processing node 20 may include an on-board fuse that permanently disables setup commands, once blown. Other suitable one-time use mechanisms may be implemented instead.

However, in other embodiments the deployment indicator need not be required. For example, the node 20 can generate an audit log 26e. The audit log 26e can provide information indicating, e.g., when keys were generated. Thus, the system 10 can receive the audit log 26e and can determine if private keys were generated prior to deployment, and if the private keys were generated prior to deployment, signing by the private keys should not be trusted.

Each satellite 12 may have an owner and each satellite 12 and owner system 14 may communicate with one another via two-way ground-based satellite communication equipment (not explicitly shown in FIG. 1). In general, each satellite owner system 14 is used for sending commands (or transactions) to the satellite via the physical-item authenticated communication channel.

In some embodiments, the operational command systems 16a-16d could communicate with associated satellites 12a, 12b, etc., via two-way ground-based satellite communication physical authenticated channels (not explicitly shown in FIG. 1) that operates via lasers. In other embodiments, only the owner systems, e.g., owner system 14a communicates with associated satellites 12a, 12b (FIG. 1), via the two-way ground-based satellite communication physically authenticated channel (FIG. 2) that operates via lasers and the operational command systems 16a-16d instead communicate transaction requests (from user systems 18) via networks (not referenced) to the owner systems 14.

In various embodiments, as noted above, there may be one or more operational command systems, e.g., 16a, 16b per satellite, e.g., satellite 12a. In various embodiments, the system 10 may include multiple (perhaps a large number) of user systems, e.g., 18a-18n per operational command system, e.g., 16a.

It should be understood that while the satellite uses the physical authenticated communication channel to authenticate earth based systems, it would be equally advantageous for earth based systems to authenticate the satellite, which could be accomplished via a laser based communication channel.

Physically Securing Satellite Link

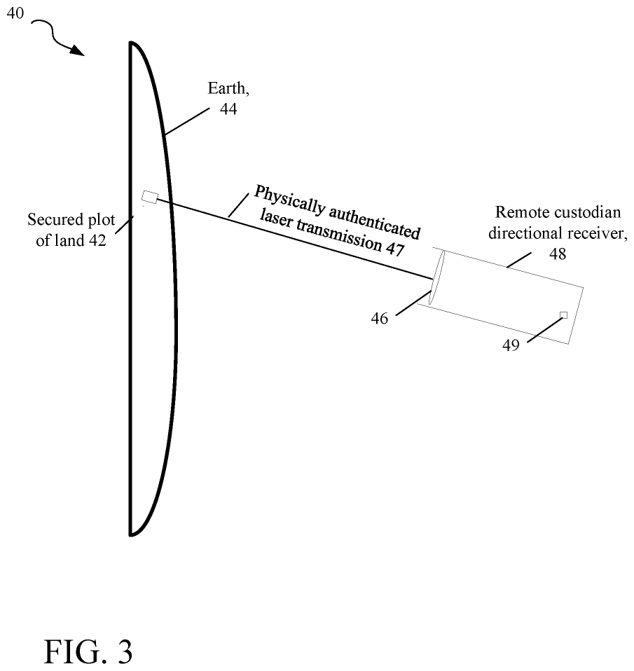

Referring now to FIG. 3, an exemplary authenticated satellite link arrangement 40 is shown. The arrangement 40 identifies the type of physical item or items which will be used to authenticate a communication channel. The items selected should be difficult or impossible to duplicate, and yet remotely identifiable by space-borne hardware, such as by satellites, without sole reliance on conventional cryptography. One natural choice would be to use one or more plots of land 42 of any suitable size, whose unique location on the Earth's 44 surface allows a satellite or other space-borne hardware to distinguish an incoming transmission from that of would-be adversaries.

For the remainder of this example, one or more plots of land 42 constitute the physical items selected for securing communication channels. There may be several advantages to using one or more plot of lands, including the ability to select a plot which is under the jurisdiction of a specific government and/or the ownership of a particular entity, perhaps in an unambiguous manner that reflects the preference of relevant parties that may include regulating agencies. Another advantage of a plot of land is that it is difficult to discretely steal. Another advantage is it might not be difficult to arrange surveillance, even simultaneously by multiple independent stakeholders, sufficient to ensure that there is no unauthorized activity taking place with or on such items.

However other types of physical items may be used. As another example, one might use a collection of long-lived qubits which were entangled with corresponding long-lived qubits inside the space-borne hardware prior to launch.

By using lasers for communication instead of traditional radio or microwave links, a high degree of security can be obtained with only a modest amount of secured land, while also keeping the satellite-side receiving hardware small—due to the diffraction characteristics of shorter wavelengths. For example, a lens 46 or mirror or series of such inside the space-borne hardware (a remote custodian directional receiver 48) could focus the incoming light on a small sensor 49 which has been carefully positioned such that only light originating from within the expected plot of land can illuminate the sensor.

Additional Security

Additional security while lowering the cost of necessary diligence, can be provided by designing the satellite to accept as valid incoming transmissions 47 only at certain pre-specified time intervals. This permits legitimate operators to employ heightened vigilance against the presence of potential adversaries on or above their plot of land during these time intervals, without incurring the added cost at other times. For example, the satellite 12a could be programmed to accept incoming commands only once a day, and only during the two minute interval from 1:00 pm GMT until 1:02 pm GMT. (Actual interval frequency and duration may be optimized for the price volatility, block rate, and other characteristics of the items held in custody.) In addition the scheduling period can be modified, so long as the modifications are known to the operator system and the satellite.

One can further improve security by designing the satellite 12a to echo back to Earth any commands it has received prior to execution, having the satellite 12a wait for an interval such as 30 seconds prior to execution, and having it listen for an incoming “panic” command during those 30 seconds. Should either the panic command or a jamming signal (including bandwidth or processor saturation) be received, the satellite could include the next time interval process 26d that cause the node 20 to revert to a safe mode where it ignores all commands received during that scheduled time interval and does nothing more until the next scheduled time interval (for example, 1:00 pm GMT the next day).

The echo and optional panic provides operators with an additional approach for both detecting and also defending against an adversary who has somehow infiltrated their plot of land for purpose of transmitting malicious commands, despite their other security measures intended to prevent it.

Custodial security can also be enhanced by implementing an extended panic command, whose receipt by the satellite is interpreted as an instruction to deactivate for a significantly longer time period, such as six months. The purpose of an extended panic command is to temporarily maintain security without diligence at the cost of availability, in the event that the operator is at substantial risk of going out of business, until such time as the operator stabilizes business operation and/or the plot of land can be acquired by an appropriate entity. The duration of an extended panic may be optimized for factors such as whether or not expedient contingency plans are in place for transitioning control quickly to a backup operator in the event of closure.

Typical Operation

A typical operational command for a remote custodian satellite will be to sign specified data, using a specified private key known only to the satellite, with a specified signature algorithm. If the satellite is being used for the secure custody of a cryptocurrency, e.g., Bitcoin, then the specified data might be a Bitcoin transaction, the specified key might be the key assigned to the custodianship of a particular account, and the algorithm selected might be ECDSA. In the case of Bitcoin, Bitcoin script may specify that this is an “n of m multisig wallet”, such that Bitcoin-native mechanisms require signatures from several but not all of certain custodial satellites, for a mixture of improved theft resistance yet with safety in the event of satellite failure.

For many blockchains and token types, similar mechanisms obviate the need for special satellite-side multi-signature support. That said, satellite-native multi-signature capabilities may also be provided by the satellites in the event that custody is required for a digital asset with no such native functionality.

One could also bury or otherwise render physically inaccessible (except by sufficiently time consuming and conspicuous effort) a fail-safe key mechanism for retrieval of assets held in custody, in the unlikely event that a sufficient quorum of satellites are lost, perhaps after assuring this backup was prepared to auditor satisfaction that no keys have been leaked during preparation, and to auditor satisfaction that the time consuming and conspicuous nature of the unearthing or otherwise accessing would allow sufficient time for the emergency removal of assets from initial custody arrangement in the event that the backup was accessed inappropriately.

Private Key Generation

As discussed above the node generates the private keys. The manner in which a satellite's private keys are generated is important, since a likely purpose of a remote custodian satellite is to assure auditors that no unknown entities possess a copy of these private keys—even regardless of operator intent, nor can they direct the use of these private keys except via access to a difficult-to-duplicate item.

Private keys may therefore be generated by the satellite, for example, by use of the bitwise exclusive or (XOR) operation to combine the output of multiple onboard high-entropy secure random number generators. Different random number generators may employ different entropy sources, such as thermal resistor noise, Geiger counter output, background microwave radiation sampling, etc., and they may be sourced from different vendors, with each designed to contribute sufficient entropy for a fully secure key even without contribution from the others, as discussed above. In this manner, the correctness of any single random number generator may ensure security of the resulting keys. Any telemetry which may leak side channel information such as high-fidelity power or CPU load monitoring, as well as any remotely programmable SDR hardware that may be present, could be disabled during sensitive key generation, usage, or other operations.

The hardware design, component sourcing and manufacturing process may be subject to external security audit to guard against intentional or accidental back doors, and chain of custody for the satellite may be carefully tracked after manufacture up to time of launch and deployment to prevent or detect tampering. Satellites may generate new private keys in response to commands coming from authorized plots of land during authorized time intervals, and the associated public keys may be transmitted back to these same plots of land for purpose of receiving assets for custody or for purpose of verifying subsequent signatures. Key generation commands may further stipulate specific uses of certain keys, or specific usage time slots to sort into an appropriate diligence tier, or may stipulate that authorized signing commands may come only from certain plots of land associated with that key's desired jurisdiction or level of security.

Auditing Satellite Configuration

Satellites may furthermore support one or more audit commands, which when received, may trigger the satellite to transmit back to Earth various information about command history or configuration state, which may assist auditors in performing their duties. For example, satellites may transmit a list of all active public keys, perhaps with associated configurations and account assignments (if any), so that auditors may independently confirm that assets are in fact held in custody by the appropriate satellites. Alternatively, satellites may transmit back signed hashes of relevant information so that auditors may confirm information already supplied to them, yet with less risk of adversaries intercepting or initiating audit communications for the purpose of deriving information that they should not know, or with less risk of auditors deriving details that they should not know despite the exact scope of allowed auditor knowledge possibly not being known at the time of satellite design and perhaps even being account specific or even being subject to change as a result of changing statutory, regulatory, contractual, or jurisdictional context or interpretation.

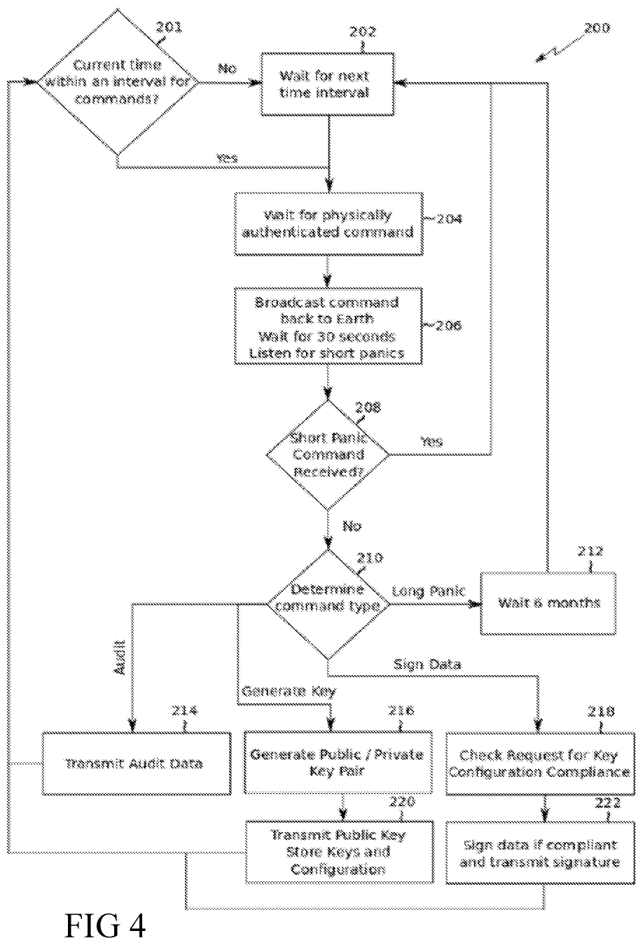

Referring now to FIG. 4, an exemplary process 200 for satellite-side processing is shown. Other approaches are also possible. At 201, the satellite determines if the current time is within one of the intervals designated for operation, for example 1:00 pm to 1:02 pm GMT, at 202, if the current time is not within the designated time period, then wait until it is before proceeding to 204. At 204, wait for a physically authenticated command to arrive over the communication channel, for example by laser transmission originating from the plot of land used to secure the channel. At 206, upon receiving a physically authenticated command, broadcast that command back to Earth and then listen for any physically authenticated “short panic” commands over the next, e.g., 30 seconds (or other time intervals, e.g., several seconds to several minutes, determined in part based on proximity of the satellite, processing links, etc.

At 208, if one or more short panic commands were received during the 30 second wait period, then discard any received commands and do nothing until the next designated time interval for operation, by going back to step 202. At 210, if no “short panic” commands were received during the 30 second wait period, then determine which command had been received during step 204.

At 214, if received command was an audit command, then transmit requested audit data back to Earth, such as a list of public keys and their configurations, or perhaps command history. Then go back to 201. At 216, if received command was a command to generate a new public/private key-pair, then generate a new key-pair of the requested type and bit length, using a combination of all available secure random number generators, combining output via bitwise exclusive or (XOR) operation, while taking appropriate safeguards against side channels such as temporarily disabling high resolution power telemetry, temporarily disabling remotely programmable software defined radio (SDR), standardizing task duration to prevent timing analysis, or any other safeguards as may be appropriate for specific hardware implementation. At 220, after key-pair is generated then store private key locally for future reference along with any specified configuration such as limitations on use, resume any features that had been disabled for safety such as SDR or power telemetry, and transmit the public key back to Earth. Then go back to step 201.

At 218, if the command type is a command to sign included data, then confirm if circumstances comply with any configured limitations for that key. Examples might include: limitations on allowed times of use (beyond the time interval limitation in step 201), limitations on which of the possibly several plots of land is authorized to use this key, limitations on the allowed signature algorithms, limitations on the type or length of data, or limitations on the total number of signature operations for that key.

At 222, if compliant then take appropriate side channel safeguards for private key use as in step 216 such as temporarily disabling power telemetry and remotely programmable SDR if any, selecting standardized task duration to prevent timing analysis, etc. Then retrieve the private key from onboard storage, sign the data as requested, undo any temporary side channel safeguards, transmit the signature back to Earth, and then proceed onto step 201. (If step 218 found command out of compliance with key configuration however, then simply skip the signature and transmission work, and skip directly back to 201.)

At 212, if the received command from step 204 was a “long panic” command, then do nothing for an extended period, e.g., days, months, etc. e.g., six months, and then proceed back to step 202. This command may be invoked if failure of the operating company is anticipated without a prompt and smooth transition, such that legal or other lengthy proceedings may be required before the plot of land can be accessed by an appropriate entity.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs (also referred to as a data processing program) (i.e., one or more modules of computer program instructions, encoded on computer storage medium for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The subject matter may be implemented on computer program instructions stored on a non-transitory computer storage medium.

The operations described in this specification can be implemented as operations performed by a data processing apparatus on data stored on one or more computer-readable storage devices or received from other sources. An example of a data processing apparatus is the data processing node 20 of FIG. 2.

The term “data processing node” encompasses all kinds of apparatus, devices, and machines for processing data, including by way of example: a programmable processor, a computer, a system on a chip, or multiple ones, or combinations, of the foregoing. The apparatus can include special purpose logic circuitry, (e.g., an FPGA (field programmable gate array) or an ASIC (application specific integrated circuit)). The apparatus can also include, in addition to hardware, code that provides an execution environment for the computer program in question (e.g., code that constitutes processor firmware, a protocol stack, a database management system, an operating system, a cross-platform runtime environment, a virtual machine, or a combination of one or more of them). The apparatus and execution environment can provide various different computing model infrastructures, such as web services, distributed computing and grid computing infrastructures.

Terrestrial systems such as the owner systems 14, operational command systems 16, user systems 18 and observer systems 19 encompasses all kinds of apparatus, devices, and machines for processing data, including by way of example a computer system or a computer embedded in another device (e.g., a mobile telephone, a personal digital assistant (PDA)), etc.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any kind of digital computer. Generally, a processor will receive instructions and data from a read only memory or a random access memory or both.

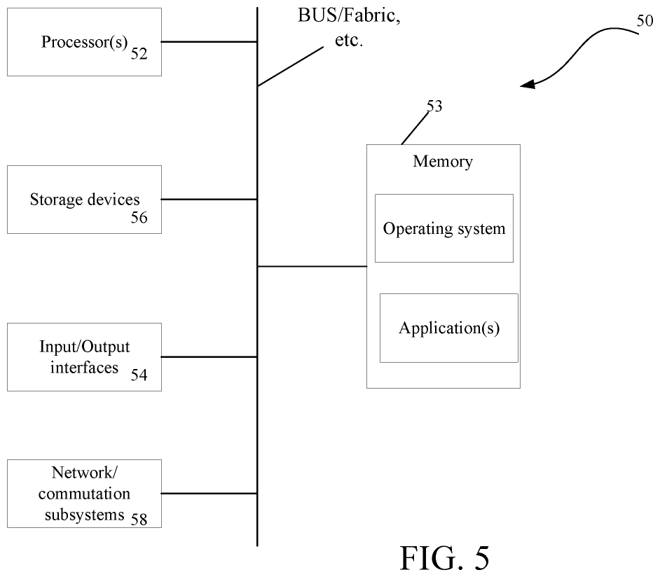

As shown in FIG. 5, the essential elements of a computer system 50 are one or more processor(s) 52 for performing actions in accordance with instructions and one or more memory devices 53 for storing instructions and data. Generally, a computer will also include, or be operatively coupled to I/O interfaces 54, network/communication subsystems 58, and one or more mass storage devices 56 for storing data (e.g., magnetic, magneto optical disks, or optical disks).

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device (monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include client and server systems that are generally remote from each other and typically interact through a communication network. The relationship of client and server arises by virtue of computer programs running on the respective computers and having a client-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, the intuitive use of the term “satellite” or “spacecraft” or “space-borne” should not be taken to exclude other potentially advantageous arrangements (e.g., platforms), including but not limited to natural bodies such as the moon nor should it be taken to exclude a mixed strategy of both orbiting and non-orbiting space-borne hardware.

What is claimed is:

1. A method of operating a deployed space-borne vehicle that includes a data processing node, the method comprises:
generating by the data processing node that is deployed to a space-borne location one or more remote custody key (RCK) pairs, the RCK pairs each including a private RCK key known only to the data processing node and a public RCK key; and
establishing a communication channel between the deployed space-borne vehicle and a terrestrial based system, with the communication channel authenticated by an earth-based physical item that is remotely identifiable by the space-borne vehicle in order for the data processing node to distinguish an incoming transmission from that of would-be adversaries.

2. The method of claim 1 further comprises:
encrypting information that is sent over the communication channel.

3. The method of claim 1 further comprising:
causing by the data processing node signing of information received over the authenticated communication channel with the private RCK key; and
transmitting the signature over the communication channel to one or more electronic devices.

4. The method of claim 1 wherein the earth-based item is a physical, earth-based location.

5. The method of claim 4 wherein the physical, earth-based item is one or more specified plots of land.

6. The method of claim 1 wherein the channel signal is transmitted by laser located within a plot of land, and the channel signal is authenticated by beam direction upon arrival at the space-borne vehicle.

7. The method of claim 1 wherein the earth-based item is a collection of long-lived qubits that were entangled with corresponding long-lived qubits inside the space-borne vehicle prior to launch, in order to distinguish an incoming transmission from that of would-be adversaries and tangible stored on non-transitory computer readable media.

8. The method of claim 1 wherein the space-borne vehicle comprises:
one or more lenses or mirrors in the space-borne vehicle to focus incoming laser beams on a sensor that is positioned such that only light originating from within the expected physical, earth-based item can illuminate the sensor.

9. The method of claim 1 wherein the method is applied to secure private keys for establishing a custodial relationship between the space-borne vehicle that is a satellite, and digital token assets.

10. The method of claim 9 wherein the digital token assets are cryptocurrency assets.

11. The method of claim 1 further comprising:
receiving an operational command over the communication channel for the data processing node to sign specified data, using a specified private key known only to the satellite, with a specified signature algorithm according to the type of assets whose custody is secured.

12. The method of claim 1, further comprising:
determining if a current time is within an interval designated for operation; upon being in the interval,
receiving by the data processing node an authenticated command;
broadcasting the authenticated command back to a system deployed on Earth;
listening for any physically authenticated “short panic” commands over a time interval.

13. The method of claim 12 when one or more short panic commands were received discard any received commands and do nothing until a next designated time interval for operation.

14. The method of claim 12 wherein when one or more short panic commands were not received during the time interval, the method further comprises:
determining the command that was received.

15. The method of claim 12 wherein the command includes one or more of an audit command, a RCK generate command, a command to sign included data, and a panic command.

16. The method of claim 1 wherein at least an initial action of generating the RCK pairs occurs upon receiving an indication of the deployment of the data processing node to the space-borne location.

17. A vehicle that is deployable to a physically inaccessible location, the vehicle comprising:
a data processing node that comprises:
one or more processor devices;
memory operatively coupled to the one or more processor devices; and
storage media that stores a computer program comprising instructions to:
generate upon being deployed to a space-borne location, one or more remote custody key (RCK) pairs, each RCK pair including a private RCK key known only to the data processing node and a public RCK key, upon receiving an indication of the deployment to the space-borne location; and
establish a communication channel between the deployed space-borne vehicle and a terrestrial based system, with the communication channel authenticated by a physical, earth-based item that is remotely identifiable by the space-borne vehicle.

18. A data processing node that comprises:
one or more processor devices;
memory operatively coupled to the one or more processor devices; and
storage media that stores a computer program comprising instructions to:
generate upon being deployed to a space-borne location, a remote custody key (RCK) pair, the RCK pair including a private RCK key known only to the data processing node and a public RCK key, upon receiving an indication of the deployment to the space-borne location; and
establish a communication channel between the deployed space-borne vehicle and a terrestrial based system, with the communication channel authenticated by a physical, earth-based item that is remotely identifiable by the space-borne vehicle.

19. A computer program product tangible stored on a non-transitory computer readable medium for configuring a data processing node that is deployable to a physically location to:
generate upon being deployed to a space-borne location, a remote custody key (RCK) pair, the RCK pair including a private RCK key known only to the data processing node and a public RCK key, upon receiving an indication of the deployment to the space-borne location; and
establish a communication channel between the deployed space-borne vehicle and a terrestrial based system, with the communication channel authenticated by a physical, earth-based item that is remotely identifiable by the space-borne vehicle.
